(19) United States
(12) Patent Application Publication
(10) Pub. No.: US 2016/0320762 A1
(43) Pub. Date: Nov. 3, 2016

(54) Automation Equipment and Method for Operating Automation Equipment

(71) Applicant: Siemens Aktiengesellschaft, Muenchen (DE)

(72) Inventors: Benjamin LUTZ, Pfinztal (DE); Gerrit WOLF, Karlsruhe (DE)

(21) Appl. No.: 15/131,660

(22) Filed: Apr. 18, 2016

(30) Foreign Application Priority Data
Apr. 28, 2015 (EP) 15165501

(51) Int. Cl. G05B 19/042

(52) U.S. Cl. CPC G05B 19/0426; G05B 2219/25011; G05B 2219/24116; G05B 2219/23258

(57) ABSTRACT

The invention relates to an automation system and a method for operating automation equipment that includes an operator system for displaying a technical process to be controlled and at least one automation device that is configured to process, for process control, CFC functions of a control program which are loaded onto the at least one automation device and are created by means of a Continuous Function Chart editor. The load on an automation device in such a system is operatively reduced in accord with the monitored load on the device, without the need to upgrade or change the hardware of the automation device, by loading corresponding CFC functions onto the operator system and switching between corresponding CFC functions on the automation device and the operator system.

### BACKGROUND OF THE INVENTION

1. Field of the Invention

The invention relates to automation equipment a method for operating automation equipment that includes an operator system for displaying a technical process to be controlled and at least one automation device that is configured for process control of CFC functions of a control program which are loaded onto the at least one automation device and are created by means of a Continuous Function Chart editor, and to a method for operating such automation equipment to selectively reduce the load(s) on the automation device(s).

2. Background of the Invention

It is known from the Siemens “SIMATIC PCS 7 Process Control System” catalog, edition 2014/15, chapter 4, that an automation solution or a user or control program for an automation device can be created, by means of a graphical editor that can run on an engineering system in the form of a so-called “Continuous Function Chart (CFC) editor”, from prefabricated modules (objects) in accordance with an automation task to be solved. To this end, the user selects the modules or objects, e.g. a controller module or counter function module, from an available stock of modules, places the modules (for example using drag and drop in a function plan such as a CFC plan), and interconnects these by clicking with the mouse. The term “interconnect” is understood here to mean that, e.g. for communication between the modules, values are transferred from an output of a module to one or more inputs of one or more modules. It is further understood to mean that one or more inputs of one or more modules are interconnected to process inputs of a process image for the transfer of actual values and/or that one or more outputs of one or more modules are interconnected to process outputs of the process image for the transfer of target values. Once the user has created all functions in the function plan, the engineering system generates, by means of the automation device, readable CFC automation objects or CFC functions, which are loaded onto the automation device and are there processed in the context of control of a technical process or to solve the automation task.

Because of the typical complexity of the plant or technical process to be controlled, several thousand CFC plans normally have to be created and the functions translated therefrom loaded onto a plurality of automation devices. The automation devices then process the functions during processing cycles, at which time an automation device could be unable to process the functions during a cycle, providing a real-time violation. The permissible processing time may be undershot, e.g. because the runtimes of the function can fluctuate considerably as a function of the process image and in addition these function runtimes are impaired because of the operating status of the automation device and/or of the plant to be controlled—such as an operating status of “Power Up”, “Normal Mode” or “Fault”. The higher the “fill level” of an automation device, i.e. the larger the number of functions to be processed, the greater the risk that the time for executing these functions is greater than the permissible cycle time of the automation device. In this case fault-free automation of the plant can no longer be guaranteed.

In an effort to largely guarantee fault-free automation, the automation components are suitably configured. The automation components are configured on the basis of various assumptions and estimates of the process or plant to be controlled, wherein for example the number of process objects to be automated is estimated. It is not possible to determine the minimum performance of the automation equipment, in particular the minimum performance of the automation devices of the automation equipment, until the engineering and “Factory Acceptance Test (FAT)” stages. Also calculated are spare capacities, which however can “dwindle” in the life cycle of a plant because, for example, one or more expansions of the plant may become necessary. Although as part of the “Factory Acceptance Test” it is possible to simulate the automation in order to determine the limits of the automation, fault-free operation of the real plant cannot however thereby be guaranteed, especially since it is difficult to add a “worst-case scenario” as part of a simulation.

To largely guarantee fault-free automation, redundant automation equipment, known from chapter 8 of the aforementioned Siemens catalog, can be used, such as at least two subsystems, with the aim of increasing the availability of a plant to be controlled. To this end the automation equipment is provided with means which, based on an event, initially determine which program should be launched in order to respond appropriately to the event. If for example during the execution of a program an event in the form of a pending alarm of the technical process to be controlled is present at a signal input of the automation system, the running program is halted at a waiting point and a program is launched to analyze the alarm and to initiate measures to eliminate the cause of the alarm. The subsystems of this automation equipment are regularly synchronized and it can therefore largely be guaranteed that the failure of one of these subsystems will not have a detrimental effect on a process to be controlled, because the other subsystem can continue the execution or processing of the corresponding part of their respective control program or the execution or processing of the corresponding parts of the control program. This type of redundantly designed automation equipment does increase the availability of the plant to be controlled, but in particular requires extra expenditures on hardware.

### SUMMARY OF THE INVENTION

It is accordingly the object of the invention provide a method for reducing the load on an automation device of the type discussed hereinabove. It is a further object of the invention to provide automation equipment suitable for the performance of the inventive method. This and related objectives are achieved by automation equipment and a method for operating automation equipment, all in accordance with the present invention and as described and disclosed herein.

A particularly advantageous feature of the invention is that without upgrading or changing the hardware, for example by providing the automation equipment with a further automation device or replacing the existing automation device by a more powerful automation device, the availability of the automation equipment is improved. An operator system that displays the technical process to be controlled, such as an operator system known from chapter 5 of the abovementioned Siemens catalog, is used in an impending overload of the automation device for processing CFC functions of the control program, wherein a dynamic and partial removal of the load on the automation device is enabled. As a result, the availability of the automation equipment is cost-effectively increased and, furthermore, production outages or plant stoppages are largely prevented.

These and other objects and features of the present invention will become apparent from the following detailed description considered in connection with the accompanying drawings. It is to be understood, however, that the drawings are designed solely for purposes of illustration and not as a definition of the limits of the invention, for which reference should be made to the appended claims.

### BRIEF DESCRIPTION OF THE DRAWINGS

In the drawings, wherein like reference numerals denote similar elements throughout the several figures:

FIG. 1 is a schematic block diagram of automation equipment in accordance with the invention;

FIG. 2 is a further schematic block diagram of the automation equipment of FIG. 1; and

FIG. 3 depicts exemplary CFC plans.

### DETAILED DESCRIPTION OF THE PRESENTLY PREFERRED EMBODIMENTS

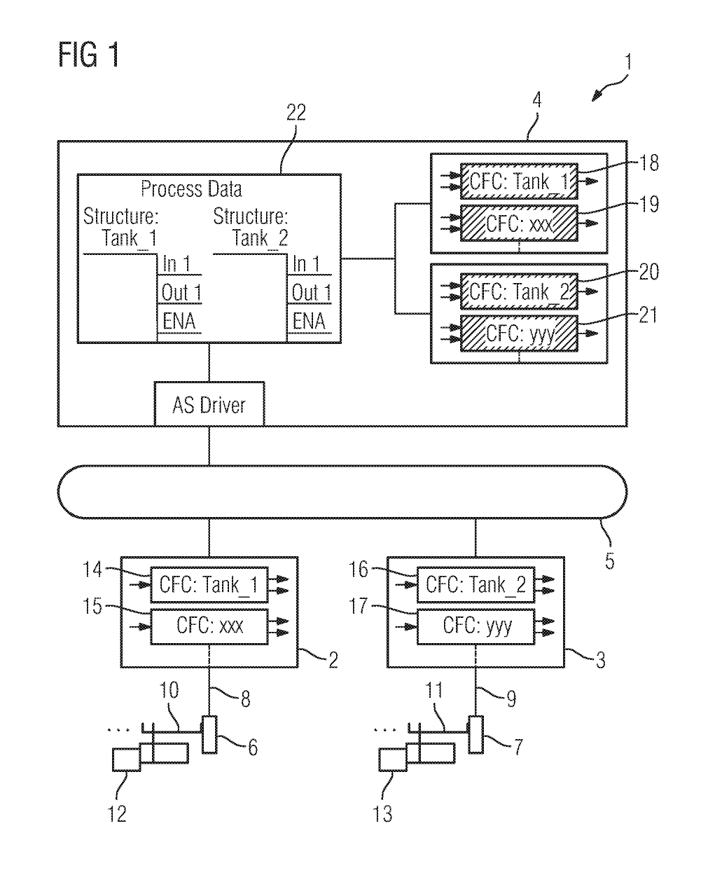

In FIG. 1 an arrangement of automation equipment in accordance with the invention is designated by the general reference numeral 1. The automation equipment 1 of FIG. 1 includes automation devices 2, 3 and an operator system implemented by an OS server 4 and an OS client (not shown). The OS server 4 communicates via a bus connection 5 with the automation devices 2, 3, and the OS server 4 and the OS client exchange information via another bus (not shown). The automation equipment 1 additionally includes local peripherals 6, 7 that are connected, respectively, via a bus 8 to the automation device 2 and via a bus 9 to the automation device 3. Other bus connections 10, 11 provide local peripherals 6, 7 with read and/or write access to a plurality of field devices 12, 13, such as sensors and actuators and the like.

Using a Continuous Function Chart (CFC) editor that can run on an engineering system (not shown), a user can graphically create, in a conventional manner, out of prefabricated modules one or more control or user programs or parts of such a program or programs for the automation devices 2, 3 in accordance with an automation task to be solved. To this end, the user selects the modules, e.g. a controller module or counter function module, from an available module stock, places the selected modules, for example using drag and drop, in a function plan (e.g. a CFC plan), and interconnects the modules by clicking with the mouse. Once the user has created all functions in the function plan, the engineering system generates, by means of the automation devices 2, 3, readable CFC functions, which are loaded onto the automation devices 2, 3 and are there processed in the context of control of a technical process or to solve the automation task. The CFC functions loaded onto the automation devices 2, 3 and there processed during the process control are designated in the FIG. 1 embodiment by reference numerals 14, 15, 16, 17, with CFC functions 18, 19, 20, 21 corresponding to the CFC functions 14 to 17 being loaded onto OS server 4. The CFC functions 18 to 21 represent copies of the CFC functions 14 to 17, although it will be appreciated that not all CFC functions 14 to 17 loaded onto automation devices 2, 3 need also be loaded onto OS server 4. In that regard, it is sufficient to load onto the OS service only those CFC functions, preferably real-time-noncritical CFC functions, that are provided for a subsequent load reduction. Which of the CFC functions are to be loaded onto OS server 4 is defined by the user during the engineering process.

In the embodiment of FIG. 1, during a RUN operation or during the process control the automation device 2 processes CFC functions 14, 15 and the automation device 3 processes CFC functions 16, 17. The CFC functions 18 to 21 loaded onto OS server 5 are deactivated, which is indicated in the drawing by cross-hatching. During this processing the automation devices 2, 3 update a process image (not shown) stored in the automation devices 2, 3 and a process image 22 stored on OS server 4 with current process input values (actual values) and process output values (target values); the process image 22 stored on OS server 4 represents the mirrored process image stored in automation devices 2, 3.

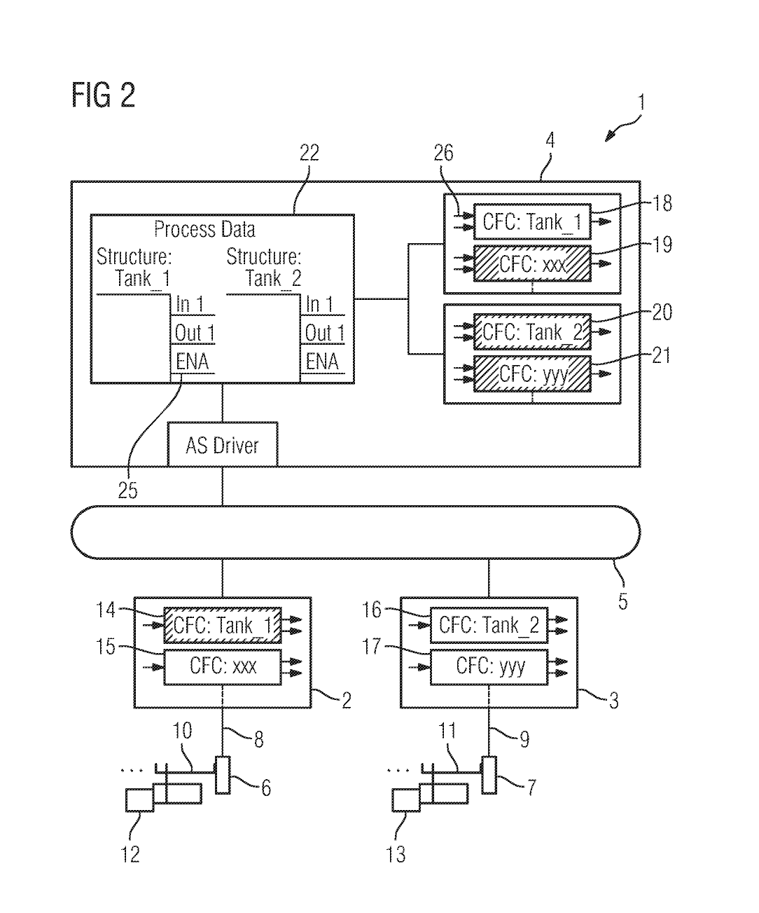

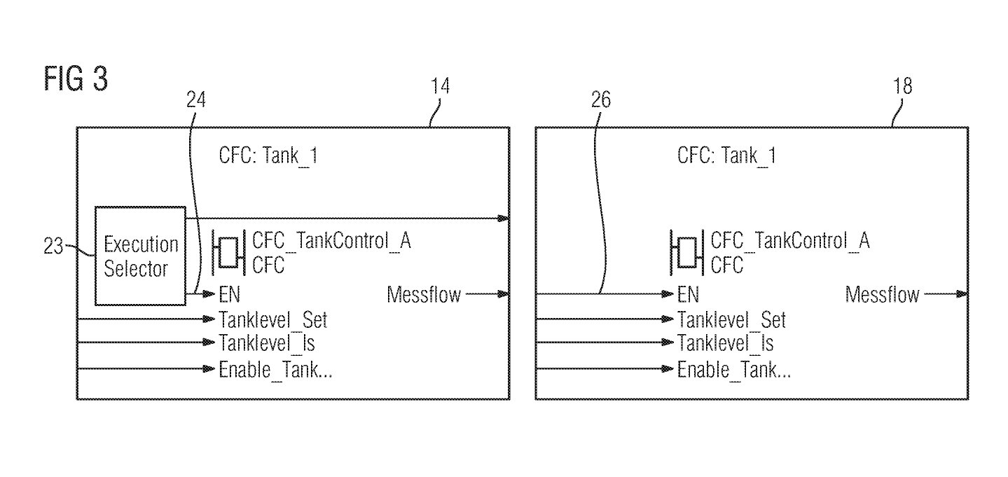

The automation devices 2, 3 capture their respective processing loads during the RUN operation, as by monitoring by the automation devices 2, 3 their respective processing cycle times. If for example the automation device 2 identifies an impending overload, an execution selector 23 (FIG. 3) of the automation device 2 deactivates the CFC function 14 (shown cross-hatched in FIG. 2) in automation device 2 and activates the CFC function 18 on OS server 4 that corresponds to CFC function 14 (see FIG. 2). The deactivation of CFC function 14 in automation device 2 is accomplished by selector 23 which applies a disabling signal to an input 24 of CFC function 14, and the activation of CFC function 18 on OS server 4 is accomplished by selector 23 which initially writes a process value 25 into the process image 22. During a process image update, the OS server reads out this “special” process value and, based thereon, generates an activation signal which OS server 4 passes to an input 26 of CFC function 18, as a result of which CFC function 18 is activated. The CFC function 18 of the control program is now processed by OS server 4, as a result of which the load on the automation device 2 is reduced. This described activation or deactivation can of course be countermanded or effected again as necessary or appropriate.

The deactivation of CFC function 14 in the automation device 2 and the activation of CFC function 18 on OS server 4 is countermanded by the selector 23 sending an enabling signal 24 to the input 23 of the CFC function and deleting the process value in process image 22.

In the present exemplary embodiment depicted in the figures the execution selector 23 for activation and deactivation of the CFC functions 14, 18 is integrated into a “CFC frame”, which comprises the CFC function 14. The automation devices 2, 3 can of course each have a selector that is provided for activation and deactivation of multiple CFC functions in the respective automation device 2, 3.

While there have been shown and described and pointed out fundamental novel features of the invention as applied to preferred embodiments thereof, it will be understood that various omissions and substitutions and changes in the form and details of the methods described and devices described and illustrated, and in their operation, may be made by those skilled in the art without departing from the spirit of the invention. It is the intention, therefore, to be limited only as indicated by the scope of the claims appended hereto.

We claim:

1. A method for operating automation equipment that includes an operator system for displaying a technical process to be controlled and at least one automation device which is configured to process, for process control, CFC functions of a control program that are loaded onto the at least one automation device and are created by means of a Continuous Function Chart editor, the method comprising:
capturing a processing load of the at least one automation device;
loading onto the operator system CFC functions that correspond to the CFC functions of the control program that are loaded onto the at least one automation device; and
activating and processing, by means of at least one selector of the at least one automation device as a function of the processing load, one of (i) at least one of the CFC functions in the at least one automation device and (ii) a CFC function in the operator system corresponding to the at least one CFC function.

2. The method of claim 1, further comprising transmitting to a process image of the operator system, by means of the selector, a process value to activate the CFC function in the operator system.

3. In an automation system that includes an operator system for displaying a technical process to be controlled, and at least one automation device that is configured to process, for process control, CFC functions of a control program that are loaded onto the at least one automation device and are created by means of a Continuous Function Chart editor,
the at least one automation device being configured to capture its processing load,
the operator system being configured to process CFC functions that are loaded onto the operator system and which correspond to the CFC functions of the control program that are loaded onto the at least one automation device, and
further comprising an execution selector of the at least one automation device for at least one of the CFC functions in the at least one automation device, the execution selector being configured to, as a function of the captured processing load, one of (i) activate one of the CFC functions in the at least one automation device and (ii) activate one of the CFC functions in the operator system corresponding to the one CFC function in the at least one automation device.

4. The automation device of claim 3, wherein the execution selector is configured to transmit a process value to a process image of the operator system to activate the one CFC function in the operator system.
